(19) United States
(12) Patent Application Publication
(10) Pub. No.: US 2025/0159644 A1
(43) Pub. Date: May 15, 2025

(54) METHOD AND APPARATUS FOR OFDM-BASED LOCAL POSITIONING SYSTEM

(71) Applicant: TOPCON POSITIONING SYSTEMS, INC., Livermore, CA (US)

(72) Inventors: Fedor Borisovich SERKIN, Moscow (RU); Nikolay Afanasyevich VAZHENIN, Moscow (RU); Vladimir Viktorovich VEITSEL, Moscow (RU); Konstantin Vladimirovich CHERESHNEV, Moscow (RU); Ilya Aleksandrovich FOMIN, Moscow (RU)

(73) Assignee: TOPCON POSITIONING SYSTEMS, INC., Livermore, CA (US)

(21) Appl. No.: 18/707,736

(22) PCT Filed: Sep. 8, 2022
(86) PCT No.: PCT/RU2022/000273

§ 371 Date: May 6, 2024

(51) Int. Cl. H04W 64/00; G01S 13/76; H04L 27/26

(52) U.S. Cl. CPC H04W 64/00; G01S 13/765; H04L 27/2601

(57) ABSTRACT

A method and apparatus is provided for determining a mobile station's position by utilizing modified Wi-Fi signals and transmitting and receiving Wi-Fi signals by a plurality of base stations, receiving signals transmitted by these base stations (which have known coordinates) and located in some proximity to the mobile station, and calculating position coordinates of the mobile station (also referred to herein as a mobile object) based on the signals.

### FIELD OF THE INVENTION

The present disclosure relates generally to radio navigation and, more particularly, to determining the location of objects when Global Positioning Satellite System signals are unavailable.

### BACKGROUND

The ability to determine current coordinates and motion parameters of movable objects (e.g., moving vehicles) using radio navigation systems is a long-standing problem and there are many well-known solutions representing a variety of techniques for such determination.

In one case, this determination can be accomplished using range-difference location methods which are often used, for example, in different navigation satellite systems, such as the U.S. Global Positioning System (GPS), the Russian GLONASS or European GALILEO. However, indoor GNSS signal reception, for example, within locations such as deep mines, canyons, or other such impenetrable formations, and/or dense urban high-rise housing developments is limited due to the restricted line-of-sight visibility of satellites in such navigation systems which results in a sharp drop in the effectiveness of such systems with respect to position determination.

To address these issues, there are techniques to determine positions of vehicles that use pseudolite signals (i.e., pseudo-satellite signals) to achieve a certain level of navigation accuracy. For example, U.S. Pat. Nos. 6,449,558, 7,495,614, 7,859,462, and 8,675,561 describe different techniques for using pseudolite signals. Alternatively, there are also a number of techniques (for example, as described in U.S. Pat. Nos. 8,738,035, and 6,449,558) that employ hybrid positioning devices which utilize both GNSS signals and other different signals supplied by ground base stations to achieve position determination. An advantage of such systems is better coverage of the desired territory and improved position accuracy. However, such systems are very complicated and expensive to deploy and function as position-determining systems instead of data-transmitting systems thereby leading to low communication channel throughput. Further, these potential limitations are compounded in that the task of developing positioning-determining and data-transmitting systems for movable objects is quite critical in delivering certain desired levels of position determination and data communication.

To overcome some of the aforementioned limitations, there are a number of positioning techniques that use Wi-Fi access points (hereinafter “AP”) and are based on measuring the strength of the received signal with a further comparison of the measured strength and the known spatial power distribution (e.g., the fingerprinting positioning method). Such a fingerprinting position methodology is described, for example, in U.S. Pat. Nos. 7,515,578, 8,155,673, and 8,838,151. These technical solutions can be used for both position-determination and data transmission/reception of movable subscribers/customers via a Wi-Fi network. Some alternative technical solutions also providing data transmission along with positioning tasks are also described, for example, in U.S. Patent Publications Nos. 2015/0087331, 2015/0099536, and 2015/0172863, respectively, wherein signals are transmitted through information channels of Wi-Fi networks. However, these known methods do not allow for obtaining highly accurate coordinate estimates (i.e., as measured in centimeter increments) and include a number of technical implementation difficulties that make deployment challenging.

Other technical solutions for position determination (e.g., as described in U.S. Pat. Nos. 7,515,578, 7,916,661, and 8,155,673) employ certain information from ground maps, Wi-Fi AP distribution, and/or coverage zones and received signal intensity to specify a mobile user's position. Further, certain other known positioning devices (e.g., as described in United States Patent Publications Nos. 2012/0075145 and 2013/0093619) employ the phase difference of signals being received by selected spaced antennas to determine the position of a movable object.

U.S. Pat. No. 7,859,462 is another known positioning technique in which a rover's position is determined using a number of reference transmitters which generate and transmit in-phase navigation signals, which are received by a rover, and determining the delays associated with the received signals for the purpose of calculating the rover's position. However, this technique cannot be directly used for transmitting information between reference transmitters and a mobile receiver/rover due to low communication channel throughput.

Therefore, a need exists for an improved technique for determining the current coordinates and motion parameters of movable objects including when GNSS signal reception is impossible or deficient in providing a desired positioning accuracy.

### SUMMARY

A method for determining a position of a mobile station includes exchanging a plurality of Wi-Fi signals among the mobile station and a plurality of base stations. The Wi-Fi signals comprise a plurality of orthogonal frequency division multiplexed (OFDM) communication signals. The position of the mobile station is determined based on the OFDM communication signals. The Wi-Fi signals can be transmitted via dual polarized or tri polarized antennas. In one embodiment, the determining the position of the mobile station based on the OFDM communication signals is further based on polarization of the OFDM communication signals. The OFDM communication signals can be based on a Pseudo Noise Sequence. A system for determining a position of a mobile station includes a mobile station and a plurality of base stations. In one embodiment, the system is configured to determine the position of the mobile station using the steps described above. A mobile station having a processor and a memory storing computer program instructions for determining the position of the mobile station is also described.

### BRIEF DESCRIPTION OF THE DRAWINGS

In the drawings, like numerals describe similar components in different Figures. Like numerals having different letter suffixes represent different instances of similar components and/or signals.

FIG. 1 shows a network including a mobile device in communication with one or more of a plurality of wireless access points;

FIG. 2 shows a signal transmission graph according to an embodiment;

FIG. 3 shows components of a master station (MSTA) including a transmitting antenna with two orthogonal polarizations;

FIG. 4 shows components of a slave station (SSTA) including transmitting and receiving antennas having two orthogonal polarizations;

FIG. 5 shows components of a Rover (mobile) station (RSTA) including an antenna having two orthogonal polarizations;

FIG. 6 shows components of a Master Station (MSTA) including a transmitting antenna with three orthogonal polarizations;

FIG. 7 shows components of a slave station (SSTA) including transmitting and receiving antennas having three orthogonal polarizations;

FIG. 8 shows components of a Rover (mobile) station (RSTA) including an antenna having three orthogonal polarizations;

FIG. 9 shows components for generating navigation signals for two antennas using Pseudo Noise Sequence (PNS) generators and digital mixers according to one embodiment;

FIG. 10 shows components for generating navigation signals for three antennas using Pseudo Noise Sequence (PNS) generators and digital mixers according to one embodiment;

FIG. 11 shows 8 tracking channels on a receiver using phase and delay measurements;

FIG. 12 shows a spectrum of Orthogonal Frequency Division Multiplexed (OFDM) signals output according to one embodiment;

FIG. 13 shows a graph of a spectrum for 12.5 MHz signals with 8 subcarriers according to one embodiment;

FIG. 14 shows a graph of a spectrum for 3.125 MHz signals with 8 subcarriers according to one embodiment;

FIG. 15 shows a graph of a spectrum for 3.125 MHz signals with 16 subcarriers according to one embodiment;

FIG. 16 shows a graph of a spectrum for 3.125 MHz signals with 32 subcarriers according to one embodiment;

FIG. 17 shows a graph of a spectrum for 12.5 MHz signals with 8 subcarriers according to one embodiment;

FIG. 18 shows a graph of a spectrum for 12.5 MHz signals with 8 subcarriers according to one embodiment;

FIG. 19 shows a graph of a spectrum for 12.5 MHz signals with 16 subcarriers according to one embodiment;

FIG. 20 shows a spectral representation of a signal according to an embodiment;

FIG. 21 a signal graph of a difference between phase estimates of subcarriers according to an embodiment;

FIG. 22 shows estimated positions of a rover mobile station according to an embodiment;

FIG. 23 shows a graph of positioning error of the estimated position of a rover mobile station according to an embodiment;

FIG. 24 shows estimated positions of a rover mobile station according to an embodiment;

FIG. 25 shows a graph of positioning error of the estimated position of the rover mobile station according to an embodiment; and

FIG. 26 shows a high-level schematic of a computer that can be used to implement various devices described herein.

### DETAILED DESCRIPTION

In accordance with the embodiments herein, a position determination is achieved through the modification of Wi-Fi access point and station signals, that are radiated by a master (i.e., guiding) base station, combined with slave (i.e., guided) stations having known coordinates, and processing the signals received from these base stations at a mobile station (or user) to calculate the desired position.

This will be further described in greater detail herein below and the discussion (and associated Figures) will employ acronyms and abbreviations including: Medium Access Control (MAC); Master Station/Master Access Point (MSTA/MAP); Orthogonal Frequency Division Multiplexing (OFDM); Physical layer (PHY); Pseudo Noise Sequence (PNS); Rover (mobile) STA (RSTA); Slave (fixed STA) (SSTA); User STA (USTA); and Wireless Local Area Network (WLAN).

In particular, in accordance with various embodiments, a method and apparatus is provided for determining a mobile station's (e.g., a rover) position by utilizing modified Wi-Fi signals (e.g. in accordance with IEEE 802.11 protocol) and transmitting and receiving Wi-Fi signals by a plurality of base stations, receiving signals transmitted by these base stations (which have known coordinates and are located in some proximity to the mobile station), measuring delay phase differences being received from different pairs of the base stations at the mobile station, and calculating position coordinates of the mobile station (also referred to herein as a mobile object) using the delay and phase differences. In one embodiment, the position of the mobile station is determined based on orthogonal frequency division multiplexed (OFDM) communication signals. In one embodiment, the OFDM communication signals included in the plurality of Wi-Fi signals. The position of the mobile station may be determined further based on polarization of the OFDM communication signals. The OFDM communication signals may be based on a pseudo noise sequence as described herein.

The position coordinate calculation is facilitated by exchanging (i.e., transmitting and receiving) Wi-Fi signals that are produced by a guiding (i.e., master) base station and a guided (i.e., slave) station(s) which are spatially located with respect to one another in a predetermined manner. The master base station and slave stations periodically transmit signals in the form of frames with an assigned structure according to a predetermined time sequence. The structure of transmitted frames contains a specially generated symbol sequence which is used for the positioning of the moving object. Service information that is needed for positioning tasks is transmitted in fields of a preamble header and in select/available information fields of such frame.

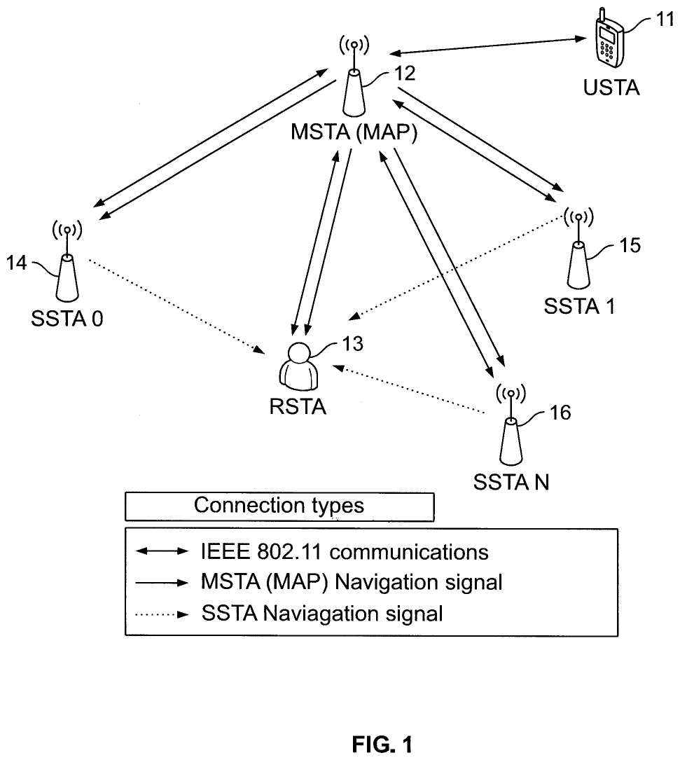

FIG. 1 shows a Master Station (MSTA) 12 in communication with User Station (USTA) 11. MSTA 12 is also in communication with Slave Station 0 (SSTA0) 14, SSTA1 15, and SSTAN16. The devices shown in FIG. 1 exchange a plurality of Wi-Fi and orthogonal frequency division multiplexed communication signals. It should be noted that there can be any number of slave stations in order to provide coverage for different size areas.

Rover Station (RSTA) 13, which is a mobile station, is in communication with MSTA 12, SSTA0 14, SSTA1 15, and SSTAN 16. In one embodiment, MSTA 12 communicates with the other devices shows in FIG. 1 via IEEE 802.11 communications which is shown by the double lead lines between opposite pointing arrow heads.

MSTA 12 transmits navigation signals (e.g., signals that are used to determine the position of a moving object, such as RSTA 13) to SSTA0 14, SSTA1 15, SSTAN 16 and RSTA 13 as shown by solid lines radiating from MSTA 12 toward each of SSTA0 14, SSTA1 15, SSTAN 16 and RSTA 13 as shown by the arrow heads on the end of the solid lines.

RSTA 13 receives navigation signals from each of SSTA0 14, SSTA1 15, SSTAN 16 as shown by the dashed lines having arrow heads pointing at RSTA 13.

The navigation signals transmitted from MSTA 12 to each of SSTA0 14, SSTA1 15, SSTAN 16 instruct the receiving devices to transmit navigation signals to RSTA 13. In one embodiment, Wi-Fi signals comprise the navigation signals and the Wi-Fi signals are exchanged among the devices shown in FIG. 1. Based on the navigation signals received by RSTA 13, the device can determine its location using measured phase delay and phase differences.

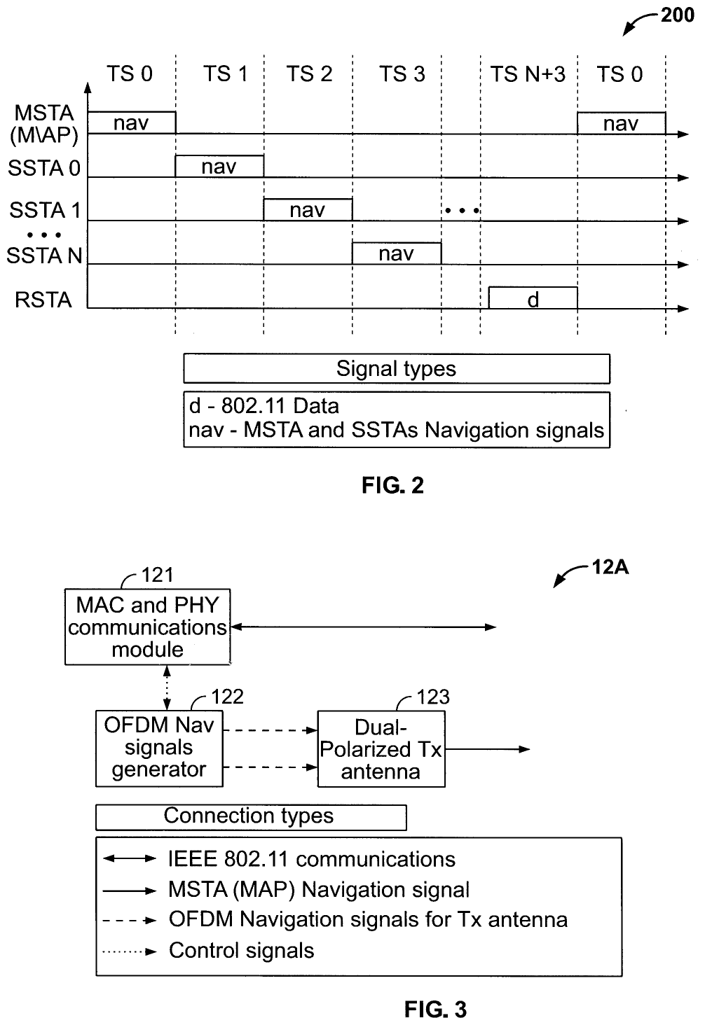

FIG. 2 shows signal graph 200 which identifies the timing of signals transmitted from the devices shown in FIG. 1. A navigation signal is transmitted from MSTA (MAP) at timing interval 0 (TS0). Navigation signals are then sequentially transmitted from SSTA0, SSTA1, SSTAN at timing intervals TS1, TS2, and TS3 respectively. It should be noted that there could be “N” number of Slave Stations that transmit navigation signals. After the “N” number of Slave Stations transmit their navigation signals, RSTA transmits 802.11 data d in at timing interval TS N+3. The sequence of navigation signals is then repeated indefinitely.

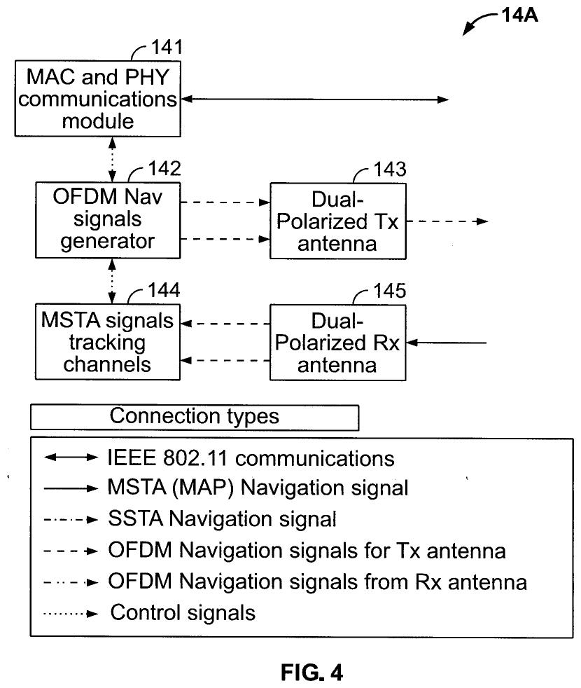

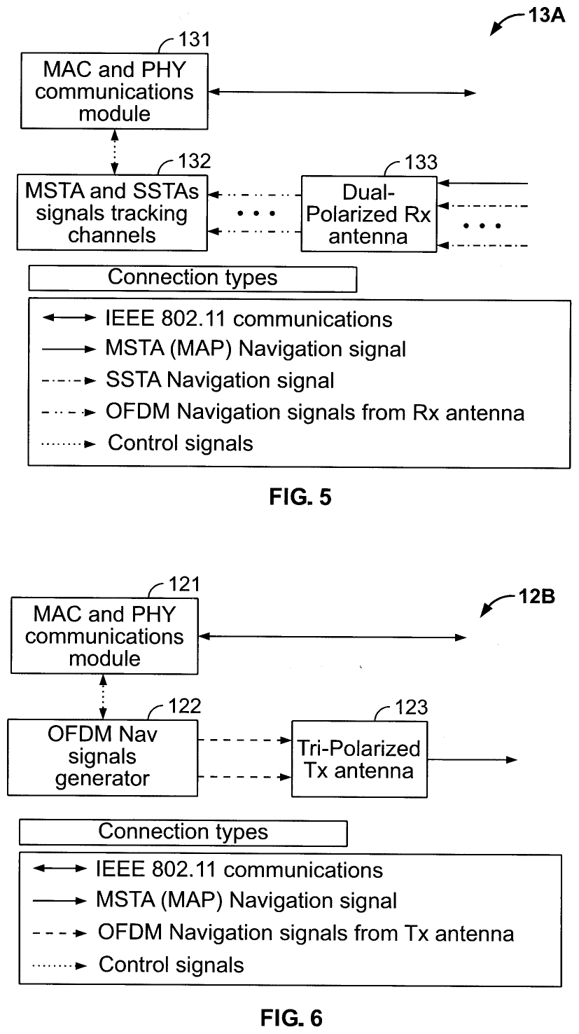

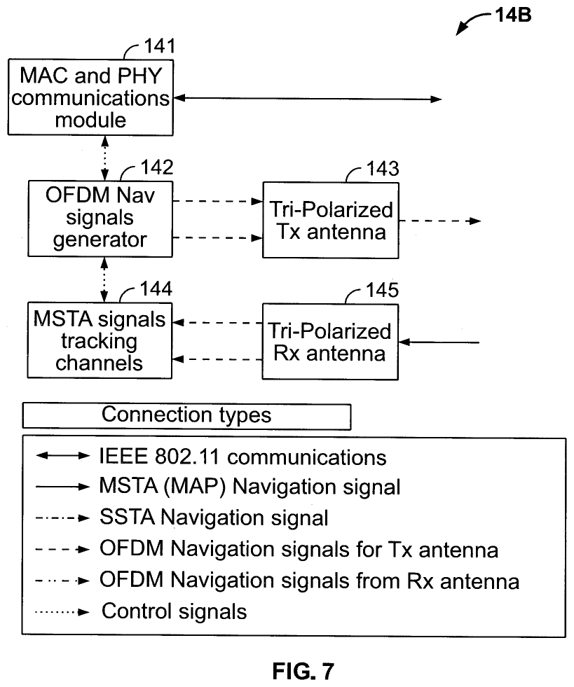

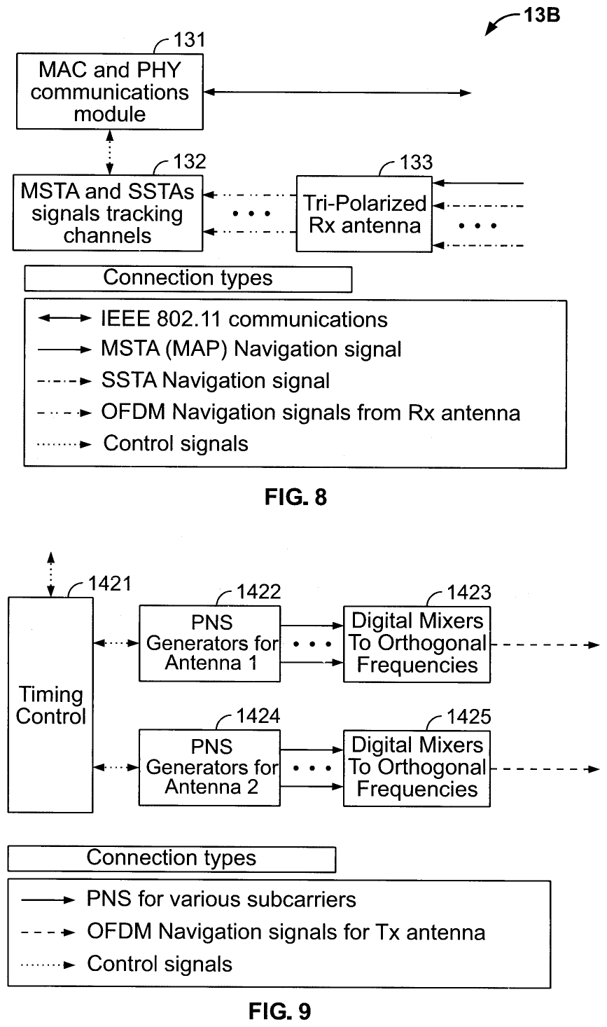

The MSTA uses a transmitting antenna using two polarizations as shown in FIG. 3 as MSTA 12A according to one embodiment or three orthogonal polarizations as shown in FIG. 6 as MSTA 12B according to another embodiment. Each SSTA uses transmitting and receiving antennas with two orthogonal polarizations as shown in FIG. 4 as SSTA 14A according to one embodiment or three orthogonal polarizations as shown in FIG. 7 as SSTA 14B according to another embodiment. The RSTA uses a receiving antenna with two orthogonal polarizations as shown in FIG. 5 as RSTA 13A according to one embodiment or three orthogonal polarizations as shown in FIG. 8 as RSTA 13B according to another embodiment. The use of different orthogonal polarizations on the transmitting and receiving antennas facilitates implementation of a large number of independent receiving channels for tracking the MSTA and SSTA signals. Using different orthogonal PNS, facilitates determination from which antenna and on which subcarrier the MSTA signal and each SSTA were emitted. The details of these embodiments are described as follows.

FIG. 3 shows MSTA 12A configured, according to one embodiment, to transmit via an antenna using two orthogonal polarizations each emitting a different orthogonal Pseudo Noise Sequence (PNS). Medium Access Control (MAC) and Physical Layer (PHY) communications module 121 transmits and receives IEEE 802.11 communications from other devices as shown in FIG. 1. MAC and PHY communications module 121 is in communication with OFDM Nav signals generator 122. Control signals are transmitted and received between MAC and PHY communications module 121 and OFDM Nav signals generator 122. In response to the control signals, OFDM Nav signals generator 122 transmits OFDM navigation signals to dual-polarized transmission (Tx) antenna 123. MSTA (MAP) navigation signals are transmitted from dual-polarized transmission (Tx) antenna 123 in response to the OFDM navigation signals.

FIG. 4 shows SSTA0 14A configured, according to one embodiment, to transmit via an antenna using two orthogonal polarizations each emitting different orthogonal PNS. MAC and PHY communications module 141 is in communication with OFDM Nav signals generator 142. Control signals are transmitted and received between MAC and PHY communications module 141 and OFDM Nav signals generator 142. In response to the control signals, OFDM Nav signals generator 142 transmits OFDM navigation signals to dual-polarized transmission (Tx) antenna 143 which, in response, transmits SSTA navigation signals. MSTA signals tracking channels 144 is in communication with OFDM signals generator 142. MSTA signals tracking channels 144 and OFDM signals generator 142 each transmit and receive control signals from one another. Dual polarized RX antenna 145 receives MSTA (MAP) navigation signals and, in response, transmits OFDM navigation signals to MSTA signals tracking channels 144. It should be noted that although FIG. 4 shows the components that are used for SSTA0 14A, the same components can used for SSTA1 15, and SSTAN 16 in addition to any number of other SSTAs.

FIG. 5 shows RSTA 13A configured, according to one embodiment, to receive signals using an antenna with two orthogonal polarizations. MAC and PHY communications module 131 is in communication with MSTA and SSTAs signals tracking channels 132. MAC and PHY communications module and MSTA and SSTAs signals tracking channels 132 each transmit and receive control signals from one another. MSTA and SSTAs signals tracking channels 132 receive SSTA navigation signals from dual polarized RX antenna 133. It should be noted that dual polarized RX antenna 133 receives MSTA (MAP) navigation signals and multiple SSTA navigation signals from multiple SSTAs.

FIG. 6 shows MSTA 12B configured, according to one embodiment, to transmit via an antenna using three orthogonal polarizations each emitting a different orthogonal Pseudo Noise Sequence (PNS). Medium Access Control (MAC) and Physical Layer (PHY) communications module 121 transmits and receives IEEE 802.11 communications from other devices as shown in FIG. 1. MAC and PHY communications module 121 is in communication with OFDM Nav signals generator 122. Control signals are transmitted and received between MAC and PHY communications module 121 and OFDM Nav signals generator 122. In response to the control signals, OFDM Nav signals generator 122 transmits OFDM navigation signals to tri-polarized transmission (Tx) antenna 123. MSTA (MAP) navigation signals are transmitted from dual-polarized transmission (Tx) antenna 123 in response to the OFDM navigation signals.

FIG. 7 shows SSTA0 14B configured, according to one embodiment, to transmit via an antenna using three orthogonal polarizations each emitting different orthogonal PNS. MAC and PHY communications module 141 is in communication with OFDM Nav signals generator 142. Control signals are transmitted and received between MAC and PHY communications module 141 and OFDM Nav signals generator 142. In response to the control signals, OFDM Nav signals generator 142 transmits OFDM navigation signals to tri-polarized transmission (Tx) antenna 143 which, in response, transmits SSTA navigation signals. MSTA signals tracking channels 144 is in communication with OFDM signals generator 142. MSTA signals tracking channels 144 and OFDM signals generator 142 each transmit and receive control signals from one another. Dual polarized RX antenna 145 receives MSTA (MAP) navigation signals and, in response, transmits OFDM navigation signals to MSTA signals tracking channels 144. It should be noted that although FIG. 7 shows the components that are used for SSTA0 14, the same components are used for SSTA1 15, and SSTAN 16 in addition to any number of other SSTAs.

FIG. 8 shows RSTA 13B configured, according to one embodiment, to receive signals using an antenna with three orthogonal polarizations. MAC and PHY communications module 131 is in communication with MSTA and SSTAs signals tracking channels 132. MAC and PHY communications module and MSTA and SSTAs signals tracking channels 132 each transmit and receive control signals from one another. MSTA and SSTAs signals tracking channels 132 receive SSTA navigation signals from tri-polarized RX antenna 133. It should be noted that dual polarized RX antenna 133 receives MSTA (MAP) navigation signals and multiple SSTA navigation signals from multiple SSTAs.

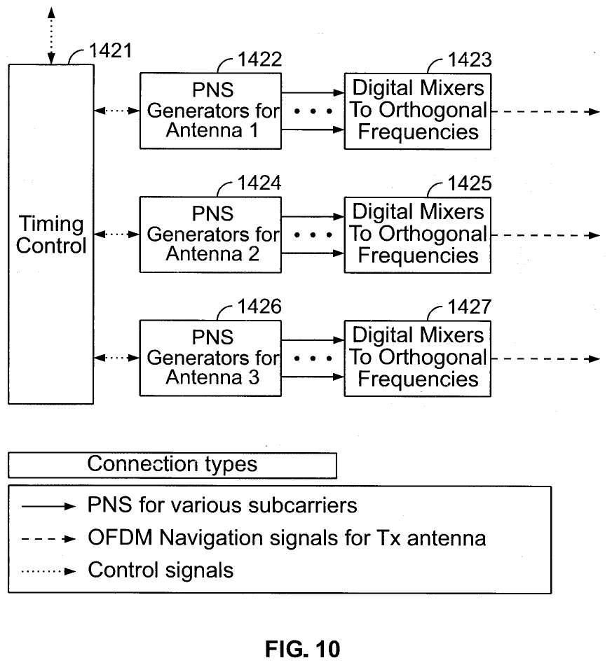

FIGS. 9 and 10 show additional details of the components used to generate signals for transmission via two antennas (FIG. 9) or by three antennas (FIG. 10).

FIG. 9 shows components for generating signals output from two antennas. Timing control 1421 receives control signals and, in response, generates control signals that are transmitted to PNS generators for antenna 1 1422 and PNS generators for antenna 2 1424. In response to received control signals, PNS generators for antenna 1 1422 generate PNS for a plurality of subcarriers that are transmitted to digital mixers for orthogonal frequencies 1423. OFDM navigations signals for a Tx antenna are output from digital mixers for orthogonal frequencies 1423. In response to the received control signals, PNS generators for antenna 2 1424 generate PNS for a plurality of subcarriers. OFDM navigations signals for a Tx antenna are output from digital mixers for orthogonal frequencies 1425.

FIG. 10 shows components for generating signals output from three antennas. Timing control 1421 receives control signals and, in response, generates control signals that are transmitted to PNS generators for antenna 1 1422, PNS generators for antenna 2 1424 and PNS generators for antenna 3 1426. In response to received control signals, PNS generators for antenna 1 1422 generate PNS for a plurality of subcarriers that are transmitted to digital mixers for orthogonal frequencies 1423. OFDM navigations signals for a Tx antenna are output from digital mixers for orthogonal frequencies 1423. In response to the received control signals, PNS generators for antenna 2 1424 generate PNS for a plurality of subcarriers. OFDM navigations signals for a Tx antenna are output from digital mixers for orthogonal frequencies 1425. PNS generators for antenna 3 1426 generate PNS for a plurality of subcarriers. OFDM navigations signals for a Tx antenna are output from digital mixers for orthogonal frequencies 1427.

In one embodiment, the use of different orthogonal polarizations for the transmitting and receiving antennas makes it possible to implement a larger number of independent receiving channels for tracking the MSTA and SSTA signals. Using different orthogonal PNS, it is determined from which antenna and on which subcarrier the MSTA signal and each SSTA were emitted.

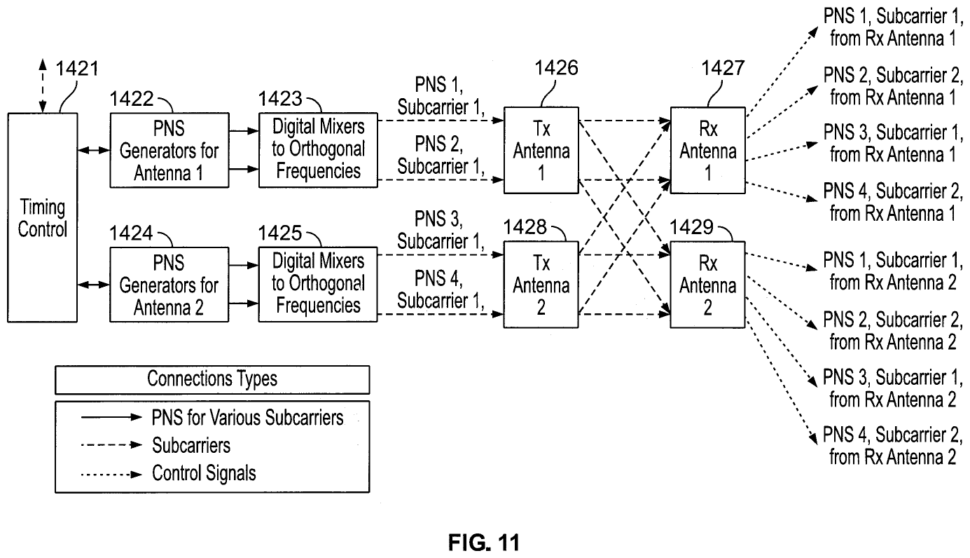

FIG. 11 shows components configured for a receiver having eight tracking channels. For example, when emitting different orthogonal PNS on two orthogonal subcarriers from each antenna, using an antenna with two orthogonal polarizations at the transmitter and the same antenna at the receiver in multipath conditions, it is possible to obtain 2×2×2=8 tracking channels on the receiver with phase and delay measurements with different multipath effects. As more antennas and more subcarriers are used, the number of channels with different multipath effects increases in accordance with the shape of the reflecting objects and the multipath correlation interval generated in the area where the system operates. FIG. 11 shows timing control 1421 receiving control signals and transmitting control signals pertaining to tracking. Timing control 1421 transmits and receives control signals from PNS generators for antenna 1 1422 and PNS generators for antenna 2 1424. PNS generators for antenna 1 1422 generate and transmit PNS for a plurality of subcarriers to digital mixers to orthogonal frequencies 1423. PNS generators for antenna 2 1424 generate and transmit PNS for a plurality of subcarriers to digital mixers to orthogonal frequencies 1425. Digital mixers to orthogonal frequencies 1423 transmits PNS 1, subcarrier 1 signals and PNS 2, subcarrier 2 signals to TX Antenna 1 1426. Digital mixers to orthogonal frequencies 1425 transmits PNS 3, subcarrier 1 signals and PNS 4, subcarrier 2 signals to TX Antenna 2 1428. TX antenna 1 transmits subcarriers to RX antenna 1 and RX antenna 2. TX antenna 2 also transmits subcarriers to RX antenna 1 and RX antenna 2. In response to received subcarrier signals RX antenna 1 transmits PNS 1, subcarrier 1 signal; PNS 2, subcarrier 2 signal; PNS 3, subcarrier 1 signal; and PNS 4, subcarrier 2 signal. In response to received subcarrier signals RX antenna 2 transmits PNS 1, subcarrier 1 signal; PNS 2, subcarrier 2 signal; PNS 3, subcarrier 1 signal; and PNS 4, subcarrier 2 signal.

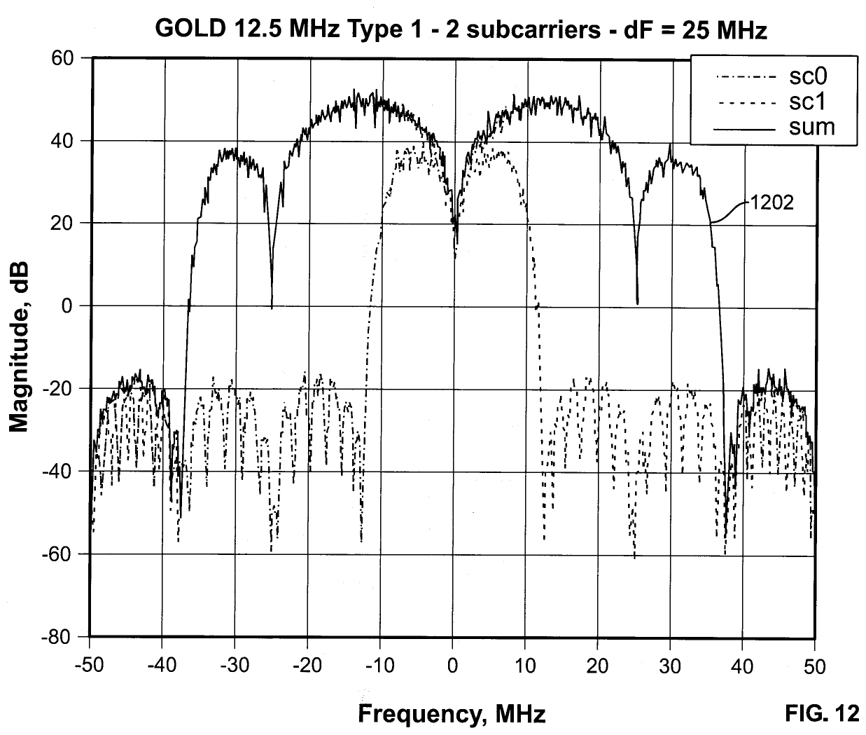

FIGS. 12 through 19 show graphs of spectra of OFDM signals output from digital mixers 1423, 1425, 1427, shown in FIGS. 9, 10, and 11. The signal represented by a solid black line in each of the graphs of FIGS. 12 through 19 represents a total signal input to a corresponding Tx antenna.

FIG. 12 shows a graph of a spectrum generated using Gold code 12.5 MHz Type 1 signals with 2 subcarriers and dF=25 MHz according to one embodiment. Signal 1202 is the total signal input to a corresponding Tx antenna.

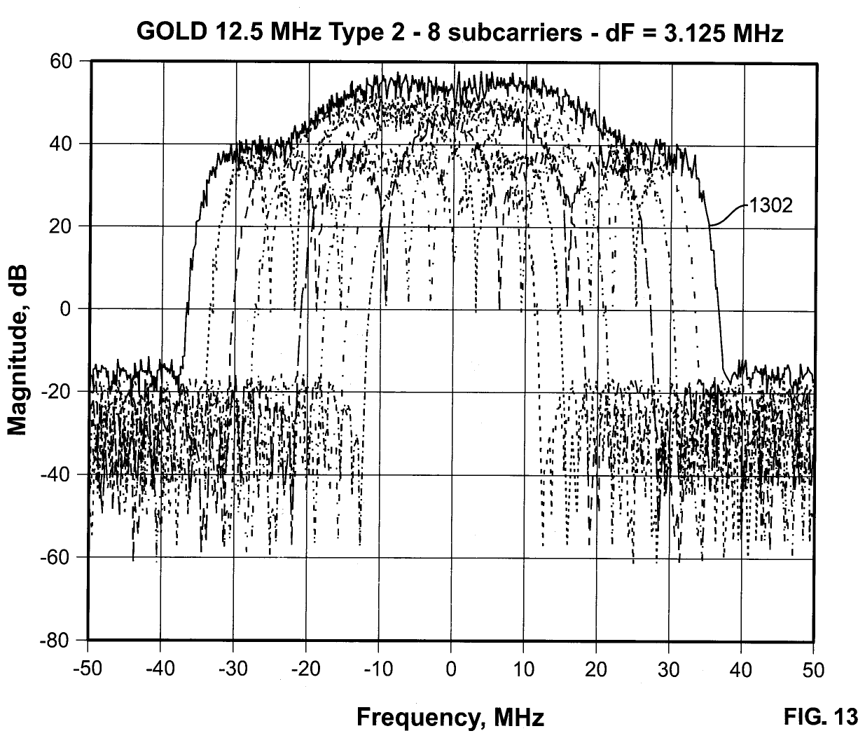

FIG. 13 shows a graph of a spectrum generated using Gold code 12.5 MHz Type 2 signals with 8 subcarriers and dF=3.125 MHz. Signal 1302 is the total signal input to a corresponding Tx antenna.

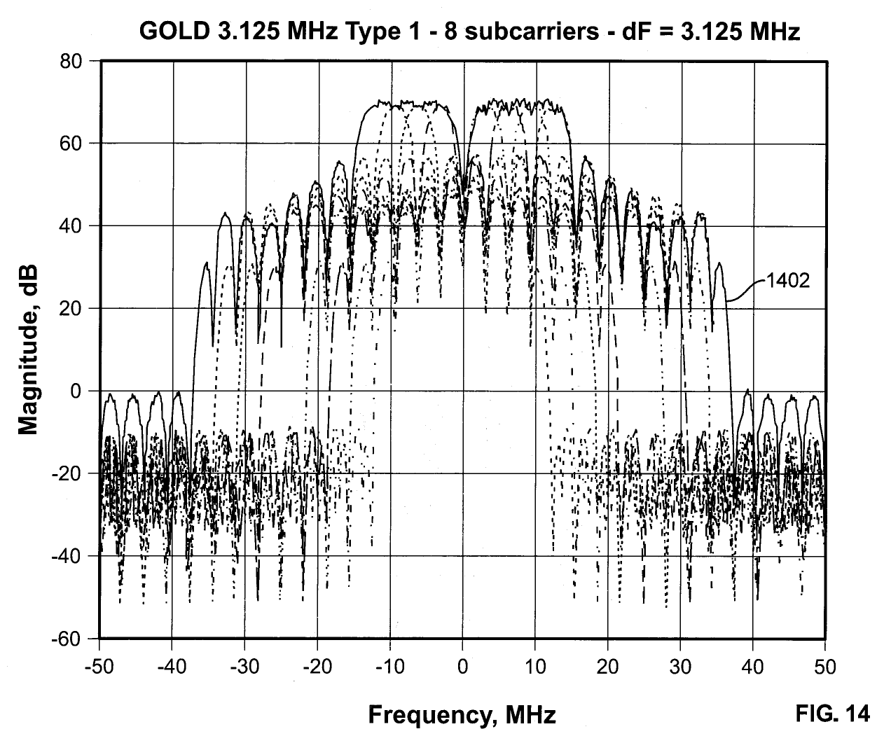

FIG. 14 shows a graph of a spectrum generated using Gold code 3.125 MHz Type 1 signals with 8 subcarriers and dF=3.125 MHz. Signal 1402 is the total signal input to a corresponding Tx antenna.

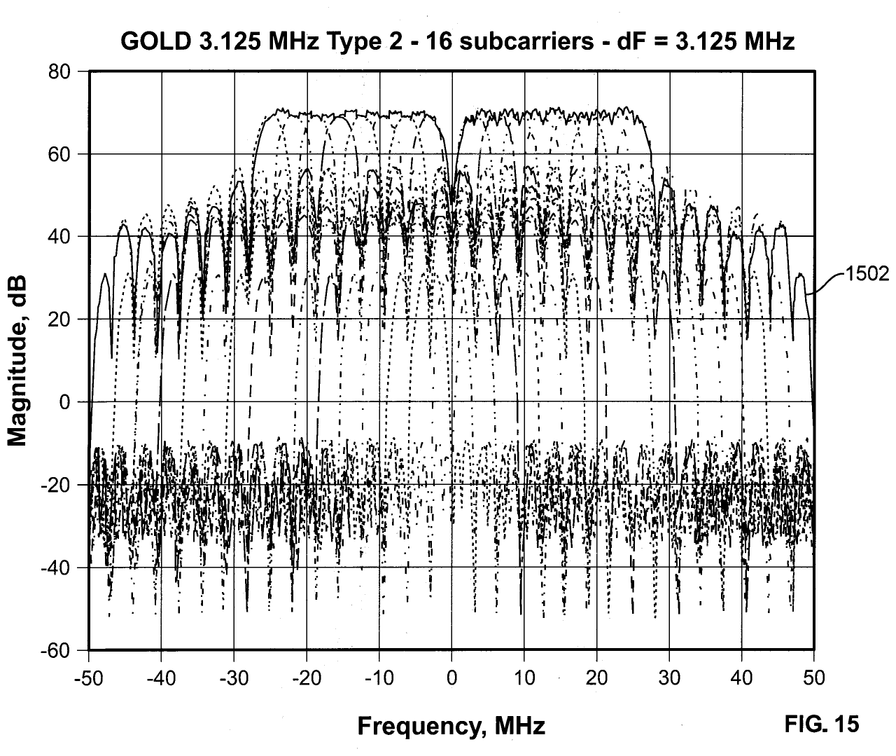

FIG. 15 shows a graph of a spectrum generated using Gold code 3.125 MHz Type 2 signals with 16 subcarriers and dF=3.125. Signal 1502 is the total signal input to a corresponding Tx antenna.

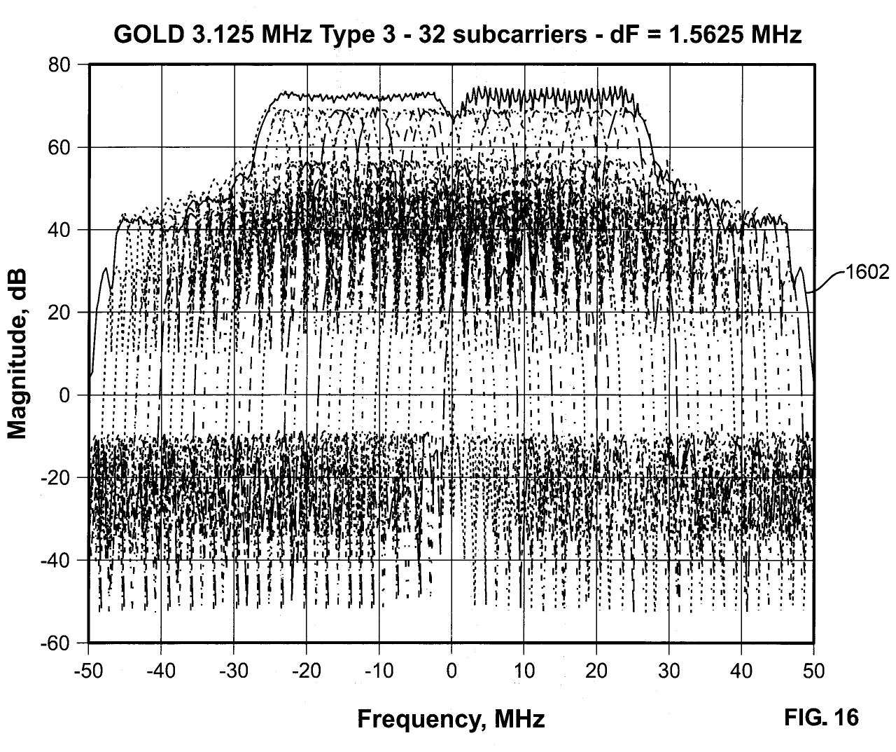

FIG. 16 shows a graph of a spectrum generated using Gold code 3.125 MHz Type 3 signals with 32 subcarriers and dF=1.5625 MHz. Signal 1602 is the total signal input to a corresponding Tx antenna.

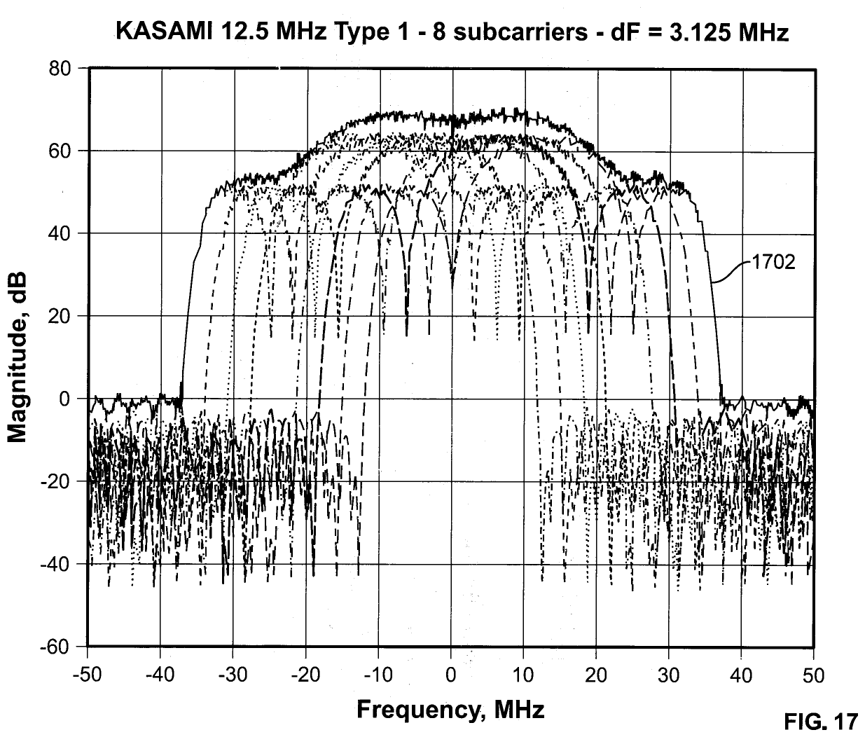

FIG. 17 shows a graph of a spectrum generated using a Kasami algorithm with 12.5 MHz Type 1 signals with 8 subcarriers and dF=3.125. Signal 1702 is the total signal input to a corresponding Tx antenna.

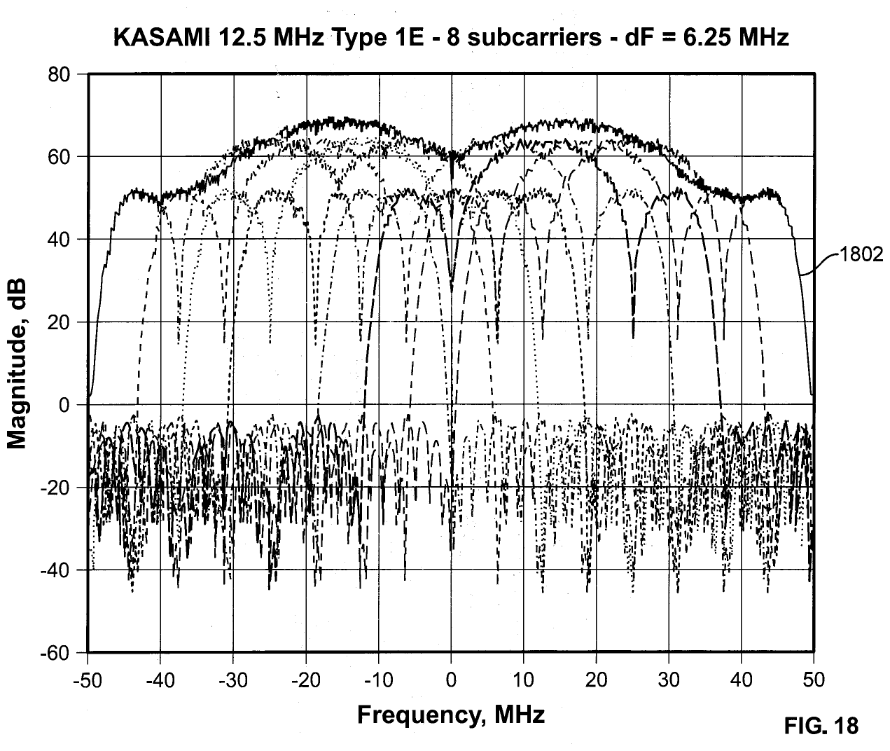

FIG. 18 shows a graph of a spectrum generated using a Kasami algorithm with 12.5 MHz Type 1 signals with 8 subcarriers and dF=6.25 MHz. Signal 1802 is the total signal input to a corresponding Tx antenna.

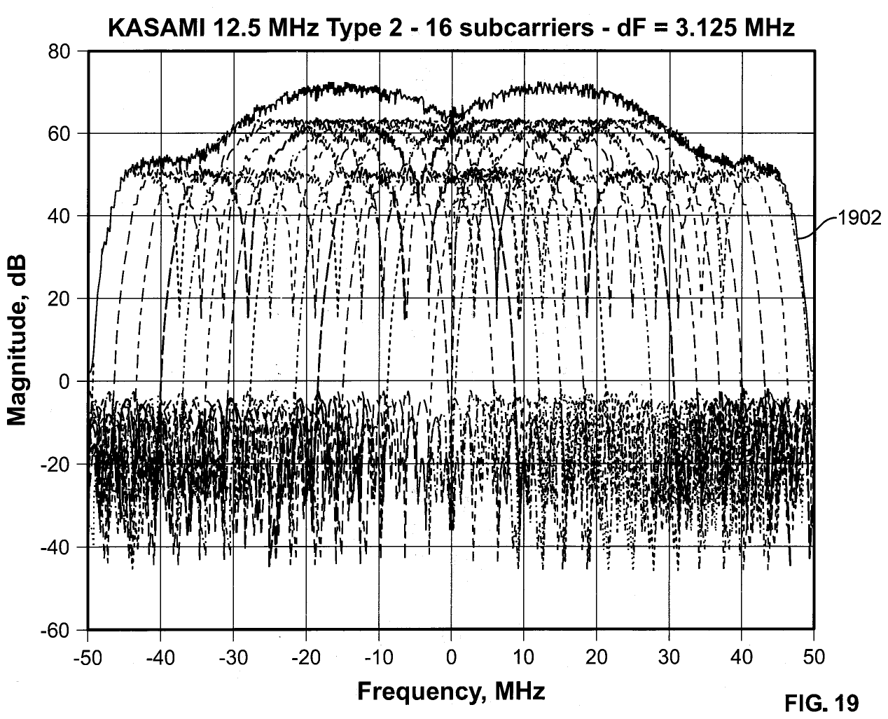

FIG. 19 shows a graph of a spectrum generated using a Kasami algorithm with 12.5 MHz Type 2 signals with 16 subcarriers and dF=3.125. Signal 1902 is the total signal input to a corresponding Tx antenna.

An advantage of the method for position determination using modified Wi-Fi access point and station signals as described herein is that it is possible to reject false measurements using one of a plurality of different algorithms such as QLL, CQLL, CoOp, Vector Tracking etc. or, for example, with the following algorithm.

In this algorithm, a positioning system uses base stations located at points of known coordinates. These base stations transmit signals, which are received and processed by the rover. The rover receives signals from multiple base stations, and uses a range-difference method or any other known method to calculate current coordinates and/or velocity.

In the simplest case, when phase measurements are performed and only relative coordinates are needed, the navigation signals can be purely harmonic signals. Additional detail can be found in literature, see, e.g., Joon Wayn Cheong et al., Characterising the Signal Structure of Locata's Pseudolite based Positioning System, International Global Navigation Satellite Systems Society IGNSS Symposium 2009 Holiday Inn Surfers Paradise, Qld, Australia 1-3 Dec. 2009; Barnes J., Rizos C., Wang J., Small D., Voigt G & Gambale N. (2003) Locata: A New Positioning Technology for High Precision Indoor and Outdoor Positioning, Proceedings 2003 International Symposium on GPS\ GNSS, 9-18; and Locata Corporation. Technology Brief, http://www.locata.com/wpcontent/uploads/2014/07/Locata-Technology-Brief-v8-July-2014-Final1.pdf each of which are incorporated herein by reference in their entirety.

Local positioning radio systems, operating in intense multipath environments when signals are transmitted from reference (base) stations, mainly present the background of the present algorithm.

When multipath signals present in a measuring radio channel, it results not only in fading effects of the received signals, but also in non-controlled signal phase jumps, the latter strongly affects the accuracy of phase measurements and hence the accuracy of rover's current coordinates.

Experimental measurements of full phase of signals from two receivers under conditions of multipath reception exhibit visible jumps of full phase, which will lead to an increase in the error of current coordinate determination. These jumps represent anomalous behavior of the full phase, and are caused by multipath reception of the signals from the respective base stations.

The core of the present algorithm is a method and its implemented apparatuses providing a reduction in effects of non-controlled jumps of received signal phases, which occur in multipath channels during propagating radio waves on the accuracy of determining coordinates of local and global positioning systems based on phase measurement methods.

A positioning system generally includes a few reference (base) stations with known coordinates Tx1 . . . TxN transmitting navigation radio signals of a predetermined structure.

A movable object-rover-receives navigation signals from the base stations and after processing them determines its current coordinates and movement speed. Any known method can be used to solve the navigation task, such as a range-difference method. To determine coordinates of a movable object in a plane, at least three base stations are necessary. When one determines coordinates in 3D space, four base stations are needed.

In practice, for many cases the number of base stations “observable” by a rover can essentially exceed a minimal number needed for solving the task of rover's current positioning.

Modern navigation positioning systems employ code and phase measurements. Phase measurements allow a considerable increase in coordinate estimation methods and make the total positioning errors essentially less than carrier wavelength.

But in practice, particularly in local positioning systems, multipath signals are present. In this case, the signal received by rover's receiver is a sum of the direct signal and

a signal/signals reflected from any local objects. The latter has different path length to the reception point and hence different phase delays. Moreover, they can be different in amplitude. In rover motion, the phase difference of these signals change and at certain time instants, these signals can become anti-phased. If signal levels are quite close, the summing signal “fades”, i.e., its signal level becomes low or even zero. In such cases, when signal takes its minimal value, there are uncontrollable hopping changes of the total signal phase.

To combat multipath effects, for example, the reception of signals to two independent antennas with different polarization can be used. In this case, antennas with common phase center can normally be used.

Multipath propagation of signals from two transmitters and their reception to two independent antennas with common phase center can be used. In this case the transmitters can operated on different carrier frequencies, which allows a more efficient multipath suppression.

When a signal is reflected from local objects, its polarization is changed, therefore, the use of antennas with different polarization ensures to eliminate simultaneous signal fading in both receiving antennas.

A similar effect is observed when a signal is received from two or more transmitters. Its advantage relates to both different antenna polarization and different transmitter frequencies.

So, signal reception to differently-polarized antennas and transmitters' different carrier frequency can serve a basis for building a multipath-immune positioning system.

Taking the above into account, reduction of multipath effects on phase measurements of navigation positioning radio systems works as follows:
transmitting navigation signals with different pseudo-random codes by base stations having known coordinates and located in space in a predetermined manner;
receiving radio signals transmitted by base stations to a multichannel correlation receiver at a mobile station;
measuring a delay difference and a phase difference of signals received from different pairs of base stations;
calculating a current mobile position according to the measured differences of phase and delay, wherein
for transmitting navigation signals the base stations use radio channels distinguishing not only in the used code but also in some other parameters, for example, in carrier frequency, polarization type, spatial position etc.;
the number of radio channels exceeds the number of channels needed for implementing navigation measurements;
radio signals from some base stations are received at a mobile station;
an estimate of current full phase of the received signal is generated in each radio channel of the multichannel correlation receiver;
change rate, for example, speed or acceleration of changing current full phase of the received signal is controlled at the output of each channel of the multichannel correlation receiver;
when an anomalous change in full phase (see FIG. 11) is present in a channel, the results of estimating current full phase of the received signal in the given channel are eliminated from the original data in solving the navigation task.

In an embodiment, when base stations are transmitting navigation signals with different polarization type, these signals are received at a mobile station in multiple antennas with the same phase center and different polarization types, the signal from the output of each antenna being fed to the input of the corresponding channel of the multichannel correlation receiver.

In addition, an anomalous change in current full phase of the received signal can be detected in each channel based on exceeding square or modulo of the first or second increment of current full phase for the preset threshold level/value. A required numerical threshold value can be determined in a calibration process of phase measurement, as well as based on experimental or simulation measurement results. As abnormal full phase change can both move down in and move up in, it is reasonable to compare the absolute value characterizing full phase change rate with a threshold. For example, it can be modulo or square of the first or second increment of current full phase.

A technical implementation of the proposed method can be made as a single-antenna receiver with redundancy of full phase estimates to increase the accuracy of evaluating local coordinates.

Navigation signals from reference stations are received by an antenna and further fed to a typical multichannel correlation receiver, at the output of which there are generated estimates of current full phase for each measuring channel, the estimates being fed to the corresponding inputs of a navigation task block/block of solving navigation task, at the output of which there are generated an estimate of rover's current coordinates (absolute or relative depending on the task solved). Moreover, the estimate of current full phase for each measuring channel from the corresponding output of multichannel correlation receiver is fed to the input of the corresponding block of change rate estimation for current full phase of the corresponding channels 1 . . . N, where an overthreshold signal is generated at exceeding the threshold of full phase change rate. The outputs of the change rate estimation block of the corresponding channels 1 . . . N are connected with corresponding inputs of a channel selection block, at the output of which there are generated signals corresponding to the channel numbers wherein the threshold has been exceeded. These numbers of measuring channels are fed to a data bus line, for example, to the N+1 input of a navigation task block, and in accordance with this information from the solution of the navigation task at the relevant step, the current estimates of full phase in the indicated channels are eliminated.

An embodiment of a block of estimating change rate of full phase 1 . . . N is shown includes a block which calculates a first or a second increment of current full phase. And a block which is responsible for squaring or taking modulo of the obtained phase increment.

The anomalous change of current full phase of the received signal in each radio channel is detected based on exceeding square or modulo of the first of second increments of current full phase for the given threshold level.

A channel selection block operates as follows: values calculated in change rate estimation block of each channel 1 . . . N are fed to its inputs. These values are compared with the threshold in each channel in threshold units 1 . . . N, at the outputs of the threshold units wherein the threshold has been exceeded, logical unit is generated, at the other outputs-logical 0. A block of generating channel numbers at its output generates data about channel numbers where in the threshold was exceeded.

An embodiment of the proposed method includes a multi-antenna receiver with redundancy of full phase estimation in order to increase the accuracy of evaluating local coordinates.

Functioning of a multi-antenna receiver is similar to that of the above considered single antenna receiver. However, the availability of more independent receiving channels ensures a higher level of compensation for multipath effects during reception of radio signals.

These rejections of false measurements in complicated multipath environments, due to a generated redundancy of measurements, increases RSTA positioning accuracy.

The method and apparatus described herein were tested in an aircraft hangar. In one embodiment, method and apparatus use the detection algorithm and elimination of the effects of multipath described above.

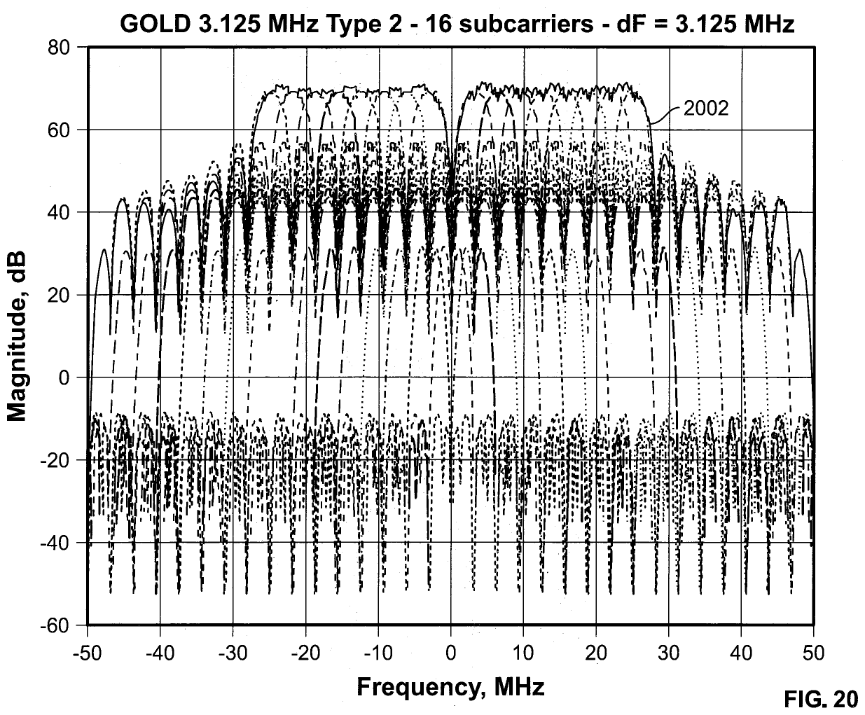

Since there is the large number of cycle slips in estimating the phase of a single signal of the transmitter, which can cause such a method to be less useful for positioning with cm-accuracy, redundancy in the transmitted signal was generated. In this frequency range, within the band up to 50 MHz and the multipath being frequency-selective, an OFDM signal with a pseudo random number based on Gold's code was generated. The spectral representation of this signal is shown in FIG. 20. In addition, to further increase the redundancy, all combinations available from orthogonal polarization at transmitters and receivers were also used. FIG. 20 shows a spectral representation of the OFDM signal with Gold's PRN. Each subcarrier is modulated by the same Gold code, with the result corresponds to the sum of subcarriers 2002.

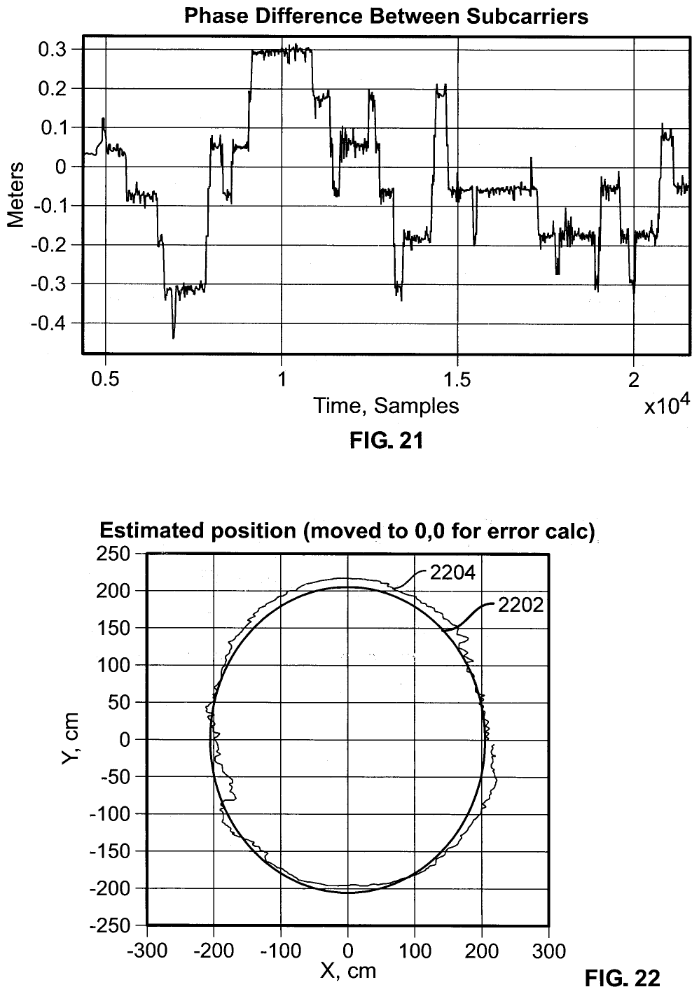

Phase estimation using the OFDM signal with Gold's PRN is made independently for each subcarrier. However, when converting phase estimates to meters, it is possible to implement an algorithm for detecting cycle slips in estimates using a catcher based on full phase estimates. In order to implement this algorithm, it is necessary to calculate the difference in the total phases between all possible pairs of subcarriers, and then, for each time point, choose an estimate of the phase of the subcarrier that is not currently subject to multipath. These operations must be performed in the receiver for each transmitter independently. Thus, estimates of increments of total phases can be obtained, from which most of the cycle slips will be excluded. FIG. 21 shows the difference in phase estimates between subcarriers. It can be seen that this parameter contains only noise and cycle slips, since the influence of the RF part, movement, and other hardware effects are the same on both subcarriers and are mutually exclusive.

As a result of applying this algorithm to the experimental data from the hangar, the algorithm achieved a root mean square (RMS) of 2-D position on the order of 10 cm as shown in FIGS. 22-25.

FIG. 22 shows a graph of estimated position of a Rover Mobile Station (RSTA) travelling in a circle according to an embodiment in which the algorithm is used. Circular path 2202 is the actual path traversed while substantially circular path 2204 is the estimated path traversed as determined by the system and method described herein.

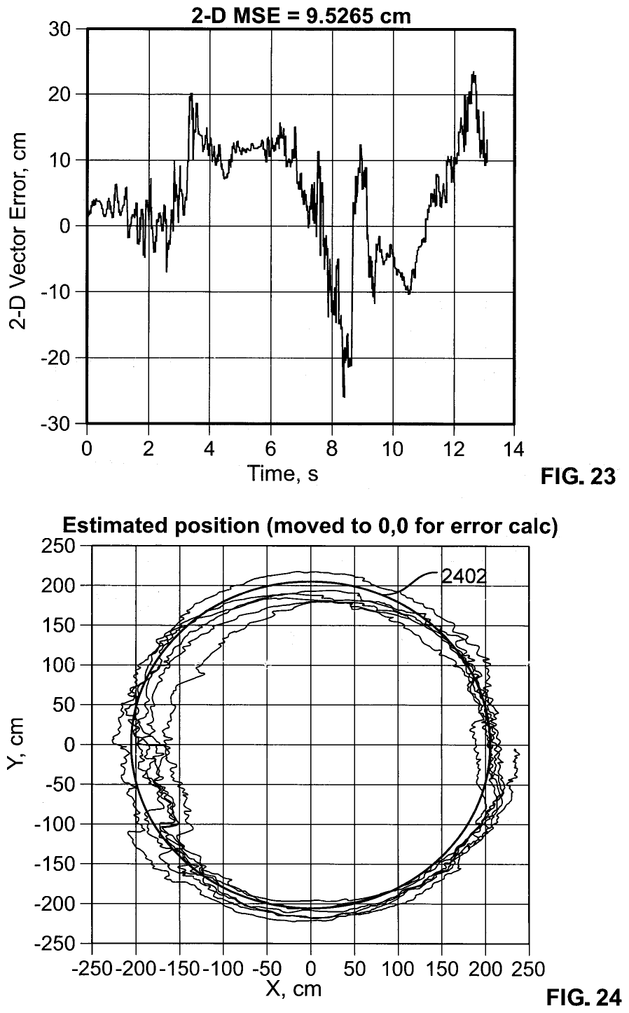

FIG. 23 shows a graph of estimated position error of the RSTA travelling in a circle as shown in FIG. 22. FIGS. 22 and 23 show a single run of the RSTA along the circular trajectory, and it is shown that 2-D RMS is smaller than 10 cm.

FIG. 24 shows a graph of estimated position of a RSTA travelling in multiple circles according to an embodiment in which the algorithm is used. Circular path 2402 is the actual path traversed while the other substantially circular graphs are the estimated paths traversed as determined by the system and method described herein.

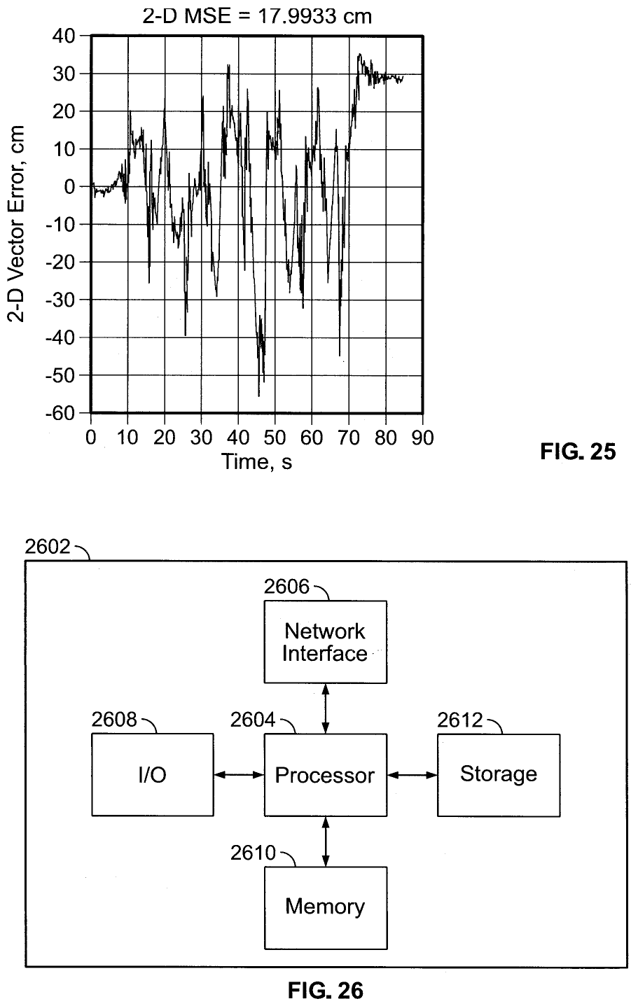

FIG. 25 shows a graph of estimated position error of the RSTA traveling in multiple circles as shows in FIG. 24. FIGS. 24 and 25 show that tracking errors are only minimally stored/accumulated in multiple runs along the trajectory. The storing/accumulating of errors can be specific to local positioning systems.

In one embodiment, a computer can be used to implement the various devices (i.e., Master Station, User Station, Slave Station, Rover Station, etc.) and also to perform the various methods and operations described herein. A high-level block diagram of such a computer is illustrated in FIG. 26. Computer 2602 contains a processor 2604 which controls the overall operation of the computer 2602 by executing computer program instructions which define such operation. The computer program instructions may be stored in a storage device 2612, or other computer readable medium (e.g., magnetic disk, CD ROM, etc.), and loaded into memory 2610 when execution of the computer program instructions is desired. Thus, the methods and operations described herein can be defined by the computer program instructions stored in the memory 2610 and/or storage 2612 and controlled by the processor 2604 executing the computer program instructions. For example, the computer program instructions can be implemented as computer executable code programmed by one skilled in the art to perform an algorithm defined by the methods and operations described herein. Accordingly, by executing the computer program instructions, the processor 2604 executes an algorithm defined by the methods and operations described herein. The computer 2602 also includes one or more network interfaces 2606 for communicating with other devices via a network. The computer 2602 also includes input/output devices 2608 that enable user interaction with the computer 2602 (e.g., display, keyboard, mouse, speakers, buttons, etc.) One skilled in the art will recognize that an implementation of an actual computer could contain other components as well, and that FIG. 26 is a high-level representation of some of the components of such a computer for illustrative purposes.

The foregoing Detailed Description is to be understood as being in every respect illustrative and exemplary, but not restrictive, and the scope of the inventive concept disclosed herein should be interpreted according to the full breadth permitted by the patent laws. It is to be understood that the embodiments shown and described herein are only illustrative of the principles of the inventive concept and that various modifications may be implemented by those skilled in the art without departing from the scope and spirit of the inventive concept. Those skilled in the art could implement various other feature combinations without departing from the scope and spirit of the inventive concept.

1. A method for determining a position of a mobile station comprising:
exchanging a plurality of Wi-Fi signals among the mobile station and a plurality of base stations, the Wi-Fi signals comprising a plurality of orthogonal frequency division multiplexed (OFDM) communication signals; and
determining the position of the mobile station based on the OFDM communication signals.

2. The method of claim 1, wherein the Wi-Fi signals are transmitted via dual polarized antennas.

3. The method of claim 1, wherein the Wi-Fi signals are transmitted via tri polarized antennas.

4. The method of claim 2, wherein the determining the position of the mobile station based on the OFDM communication signals is further based on polarization of the OFDM communication signals.

5. The method of claim 3, wherein the determining the position of the mobile station based on the OFDM communication signals is further based on polarization of the OFDM communication signals.

6. The method of claim 4, wherein the OFDM communication signals are based on a Pseudo Noise Sequence.

7. The method of claim 5, wherein the OFDM communication signals are based on a Pseudo Noise Sequence.

8. A system comprising:
a mobile station; and
a plurality of base stations,
wherein the system is configured to perform operations comprising:
exchanging a plurality of Wi-Fi signals among the mobile station and the plurality of base stations, the Wi-Fi signals comprising a plurality of orthogonal frequency division multiplexed (OFDM) communication signals; and
determining a position of the mobile station based on the OFDM communication signals.

9. The system of claim 8, wherein the Wi-Fi signals are transmitted via dual polarized antennas.

10. The system of claim 8, wherein the Wi-Fi signals are transmitted via tri polarized antennas.

11. The system of claim 9, wherein the determining a position of the mobile station based on the OFDM communication signals is further based on polarization of the OFDM communication signals.

12. The system of claim 10, wherein the determining a position of the mobile station based on the OFDM communication signals is further based on polarization of the OFDM communication signals.

13. The system of claim 11, wherein the OFDM communication signals are based on a Pseudo Noise Sequence.

14. The system of claim 12, wherein the OFDM communication signals are based on a Pseudo Noise Sequence.

15. A mobile station comprising:
a processor; and
a memory, storing computer program instructions, which when executed by the processor, cause the processor to perform operations comprising:
receiving a plurality of Wi-Fi signals from a plurality of base stations, the Wi-Fi signals comprising a plurality of orthogonal frequency division multiplexed (OFDM) communication signals; and
determining a position of the mobile station based on the OFDM communication signals.

16. The mobile station of claim 15, wherein the Wi-Fi signals are transmitted via dual polarized antennas.

17. The mobile station of claim 15, wherein the Wi-Fi signals are transmitted via tri polarized antennas.

18. The mobile station of claim 16, wherein the determining the position of the mobile station based on the OFDM communication signals is further based on polarization of the OFDM communication signals.

19. The mobile station of claim 17, wherein the determining the position of the mobile station based on the OFDM communication signals is further based on polarization of the OFDM communication signals.

20. The mobile station of claim 18, wherein the OFDM communication signals are based on a Pseudo Noise Sequence.
